(19) United States
(12) Patent Application Publication
(10) Pub. No.: US 2010/0103876 A1
(43) Pub. Date: Apr. 29, 2010

(54) MOBILE TERMINAL AND COMMUNICATION MANAGEMENT DEVICE

(75) Inventor: Keigo Aso, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/530,693

(22) PCT Filed: Mar. 17, 2008
(86) PCT No.: PCT/JP2008/000612

§ 371 Date: Sep. 10, 2009

(30) Foreign Application Priority Data
Mar. 16, 2007 (JP) 2007-069572
Mar. 11, 2008 (JP) 2008-061717

(51) Int. Cl. H04W 88/02

(52) U.S. Cl. 370/328

(57) ABSTRACT

A technology is disclosed for actualizing flow filtering associated with a packet destined for a mobile terminal while minimizing processes performed by the mobile terminal in a network environment in which a network-based mobility protocol is operating. In the technology, a mobile node 10 having two communication interfaces (IF_A 101 and IF_B 103) is connected via one communication interface (IF_A) to a network in which a network-based mobility protocol (such as PMIPv6) is operating. At this time, the mobile node gives notification from the IF_A of an address 2 set on the other communication interface (IF_B) to a proxy node 50 functioning as a proxy for the mobile node. The proxy node notifies a home agent 70 of the address, allowing the home agent 70 to select either the address 1 or the address 2 as a packet transfer destination.

### TECHNICAL FIELD

The present invention relates to a mobile terminal that is connected to a network in which a network-based mobile protocol, such as proxy mobile internet protocol version 6 (proxy mobile IPv6), is operating, and a communication management device that manages communication by the mobile terminal performed using the network.

### BACKGROUND ART

Conventionally, mobile IPv6, described in Non-patent Document 1 below, exists as a host-based layer 3 mobility control protocol (mobility protocol). On the other hand, proxy mobile IPv6, described in Non-patent Document 2 below, exists as a network-based layer 3 mobility control protocol.

In mobile IPv6 that is the host-based protocol, a mobile terminal (mobile node

[MN]) itself performs processes, from movement detection to registration of location information (care-of address).

When the mobile terminal has a plurality of communication interfaces (referred to, hereinafter, simply as interfaces) through use of a technique for registering a plurality of care-of addresses, described in Non-patent Document 3 below, the plurality of care-of addresses each assigned to an interface can be associated with a single home address and registered. At this time, a binding unique identifier (BID) is added to each registered binding cache. When the care-of address is registered, updated, or deleted, the BID is used as information identifying the binding cache entry.

When a network node performing a transfer process for a packet destined for the mobile terminal knows the plurality of care-of addresses associated with the mobile terminal, the network node can selectively change the path over which the packet destined for the mobile terminal travels (the interface by which the mobile terminal receives the packet), in adherence to a condition or a policy of some sort. Flow filtering is thus actualized.

On the other hand, in the network-based mobility protocol, because mobility management of the mobile terminal is performed on the network side, the mobile terminal itself is not required to perform processes for mobility control. Each network within a domain implementing the network-based protocol is configured such that a same home prefix is always advertised to a certain mobile terminal. Therefore, even when the network to which the mobile terminal is connected changes, the address is not required to be changed. The mobile terminal can operate as a simple IPv6 node and is not required to be aware of the presence of a home agent ([HA], or a local mobility anchor [LMA]).

However, on the network side, a proxy node (a proxy mobile agent [PMA] or a mobile access gateway [MAG] in PMIPv6) performs mobility control on behalf of the mobile terminal. The proxy node advertises the home prefix to the mobile terminal, and at the same time, registers an address of the proxy node itself at the HA as location information of a movement destination of the mobile terminal. As a result, the packet destined for the home address of the mobile terminal is transferred to the proxy node after being received by the HA as proxy. The packet is then further transmitted from the proxy node to the mobile terminal.

Non-patent Document 1: D. Johnson, C. Perkins, J. Arkko, “Mobility Support in IPv6”, RFC3775, June 2004

Non-patent Document 2: S. Gundavelli, K. Leung, V. Devarapalli, “Proxy Mobile IPv6”, draft-sgundave-mipv6-proxymipv6-00, October 2006

Non-patent Document 3: R. Wakikawa, T. Ernst, K. Nagami, “Multiple Care-of Addresses Registration”, draft-ietf-monami6-multiplecoa-00.txt, June 2006

When the mobile terminal having two interfaces on which different addresses are set connects to a domain implementing the network-base mobility protocol on at least one interface, flow filtering may be difficult to achieve.

In an operation based on the network-based mobility protocol, a packet addressed to the home address of the mobile terminal is received by the HA as proxy, and then transmitted to the mobile terminal via the proxy node. Therefore, flow filtering can be actualized if the HA knows the plurality of addresses of the mobile terminal (assigned to each interface of the mobile terminal).

However, a network implementing the network-based mobility protocol is basically transparent to the mobile terminal. The mobile terminal cannot easily know the location information of the HA within the network implementing the network-based mobility protocol. To enable the mobile terminal to know the location information of the HA, increase in processing load and traffic may occur.

Even when the mobile terminal can know the location information of the HA within the network implementing the network-based mobility protocol, the mobile node is required to implement a host-based mobility protocol so that the mobile node itself can perform a process for registering an address at the HA. However, the network-based mobility protocol attempts to actualize mobility support for a mobile terminal that does not support mobility, such as an ordinary IPv6 node. When the host-based mobility protocol is implemented, advantages of network-based mobility management are lost.

### DISCLOSURE OF THE INVENTION

To solve the above-described issues, an object of the present invention is to provide a mobile terminal and a communication management device that actualizes flow filtering associated with a packet destined for the mobile terminal while minimizing processes performed by the mobile terminal in a network environment in which a network-based mobility protocol is operating.

To achieve the above-described object, a mobile terminal of the present invention includes at least two communication interfaces. The mobile terminal also includes an address setting means for setting an address on each communication interface. The mobile terminal also includes a judging means for judging whether a communication interface is connected to a domain network in which a network-based mobility protocol is operating. The mobile terminal also includes an other interface address notifying means for giving notification of an address set on a second communication interface differing from a first communication interface connected to the domain network in which the network-based mobility protocol is operating to a proxy node. The proxy node functions as a proxy for the mobile terminal and is located on the domain network to which the first communication interface is connected.

As a result of the configuration, in a network environment in which a network-based mobility protocol is operating, a network can be notified of the address set on the other communication interface of the mobile terminal (the communication interface differing from the communication interface connected to the network in which the network-based mobility protocol is operating), while minimizing processes performed by the mobile terminal. Flow filtering associated with a packet destined for the mobile terminal can be actualized.

In addition to the above-described configuration, the mobile terminal of the present invention includes a neighbor advertisement message transmitting means for inserting the address set on the second interface into a neighbor advertisement message, and transmitting the neighbor advertisement message including the second address to the proxy node.

As a result of the configuration, address notification can be performed through use of the neighbor advertisement message in which the address set on the communication interface is inserted.

In addition to the above-described configuration, in the mobile terminal of the present invention, when the neighbor advertisement message transmitting means receives a neighbor solicitation message from the proxy node including information requesting the address set on the second communication interface differing from the first communication interface connected to the domain network, the neighbor advertisement message transmitting means transmits the neighbor advertisement message including the second address.

As a result of the configuration, when the neighbor solicitation message including the address request information is received from the proxy node located on the network side, address notification can be performed through use of the neighbor advertisement message in which the address set on the communication interface is inserted.

In addition to the above-described configuration, the mobile terminal of the present invention includes a binding update transmitting means for, when the communication interface connected to the domain network in which the network-based mobility protocol is operating is not present, giving notification of the address set on the second communication interface to a home agent of the mobile terminal from the second communication interface.

As a result of the configuration, when notification of the address cannot be made via the domain network in which the network-based mobility protocol is operating, switching can be performed such that address notification is performed from the communication interface to which the address is assigned, in a manner similar to a conventional manner.

In addition to the above-described configuration, in the mobile terminal of the present invention, when location information in which a care-of address assigned to a communication interface is associated with a home address is registered at a home agent, the judging means judges whether a communication interface differing from the communication interface to which the care-of address to be registered is assigned is connected to a network that manages the home address in the location information and implements the network-based mobility protocol. The other interface address notifying means gives notification of the location information to the proxy node that functions as the proxy for the mobile terminal from the communication interface connected to the network that manages the home address in the location information and implements the network-based mobility protocol.

As a result of the configuration, when, for example, a handover or the like is performed and location information is required to be transmitted to the home agent, whether a communication interface connected to the home network (the network in which the home agent is located) is present is checked. When a communication interface connected to the home network is present, the location information is transmitted via the communication network. As a result, processing and time required for a home agent retrieval process can be eliminated. The location information can be updated via a highly reliable home network.

In addition to the above-described configuration, the mobile terminal of the present invention includes a binding update transmitting means for, when the communication interface connected to a network that manages the home address in the location information and implements the network-based mobility protocol is not present, giving notification of the location information to a home agent of the mobile terminal from the communication interface to which the care-of address to be registered is assigned.

As a result of the configuration, when notification of the location information cannot be made via the communication interface connected to the home network, switching can be performed such that notification of the location information can be made from the communication interface to which the care-of address is assigned, in a manner similar to a conventional manner.

To achieve the above-described object, a communication management device of the present invention includes a proxy node function executing means for providing a function as a proxy for a mobile terminal connected to a domain network implementing a network-based mobility protocol and in which the network-based mobility protocol is operating. The communication management device also includes an other interface address receiving means for receiving, from a mobile terminal that has at least one communication interface, an address set on another communication interface differing from a communication interface of the mobile terminal connected to the domain network.

As a result of the configuration, in a network environment in which a network-based mobility protocol is operating, a network can be notified of the address set on the other communication interface of the mobile terminal (the communication interface differing from the communication interface connected to the network in which the network-based mobility protocol is operating), while minimizing processes performed by the mobile terminal. Flow filtering associated with a packet destined for the mobile terminal can be actualized.

In addition to the above-described configuration, the communication management device of the present invention includes an address requesting means for inserting address request information into a neighbor solicitation message and transmitting the neighbor solicitation message including the address request information to the mobile terminal. The address request information request the address set on the other communication interface differing from the communication interface of the mobile terminal connected to the domain network.

As a result of the configuration, address request can be performed through use of the neighbor solicitation message in which the address request information is inserted. The address request information requests the address set on the communication interface, among the communication interfaces of the mobile terminal, differing from the communication interface connected to the network in which the network-based mobility protocol is operating.

In addition to the above-described configuration, the communication management device of the present invention includes a transfer destination address notifying means for registering the address set on the other communication interface, received from the other interface address receiving means, at a certain address management device as a potential packet transfer destination for a packet destined for the mobile terminal. The certain address management device transfers the packet destined for the mobile terminal connected to the domain network and manages an address of the mobile terminal.

As a result of the configuration, an address management device that transfers the packet destined for the mobile terminal can know the address set on the communication interface differing from the communication interface connected to the network in which the network-based mobility protocol is operating and set the address as the packet transfer destination.

The present invention has the above-described configuration. The present invention achieves an effect in which flow filtering associated with a packet destined for a mobile terminal can be actualized while minimizing processes performed by the mobile terminal in a network environment in which a network-based mobility protocol is operating.

### BRIEF DESCRIPTION OF THE DRAWINGS

FIG. 1 is a diagram of an example of a network configuration according to a first embodiment of the present invention;

FIG. 2 is a block diagram of an example of a configuration of a mobile node according to the first embodiment of the present invention;

FIG. 3 is a diagram of an example of an NA message transmitted by the mobile node according to the first embodiment of the present invention;

FIG. 4 is a diagram of another example of the NA message transmitted by the mobile node according to the first embodiment of the present invention;

FIG. 5 is a block diagram of an example of a configuration of a proxy node according to the first embodiment of the present invention;

FIG. 6 is a diagram of an example of a proxy BU message transmitted by the proxy node according to the first embodiment of the present invention;

FIG. 7 is a diagram of an example of a proxy BU message option transmitted by the proxy node according to the first embodiment of the present invention;

FIG. 8 is a diagram of an example of an NS message transmitted by the proxy node according to the first embodiment of the present invention;

FIG. 9 is a diagram of an example of an RA message transmitted by the proxy node according to the first embodiment of the present invention;

FIG. 10 is a block diagram of an example of a configuration of a home agent according to the first embodiment of the present invention;

FIG. 11 is a sequence chart of an example of operations performed in an overall system according to the first embodiment of the present invention;

FIG. 12 is a diagram of an example of a network configuration according to a second embodiment of the present invention;

FIG. 13 is a sequence chart of an example of operations performed in an overall system according to the second embodiment of the present invention;

FIG. 14 is a diagram of an example of a network configuration according to a third embodiment of the present invention;

FIG. 15 is a diagram of an example of a configuration of a mobile node according to the third embodiment of the present invention;

FIG. 16 is a flowchart of an example of processes performed by a connected network identifying section and related constituent elements of the mobile node when the mobile node is connected to a certain network, according to the third embodiment of the present invention;

FIG. 17 is a diagram of an example of a configuration of a proxy node according to the third embodiment of the present invention; and

FIG. 18 is a diagram of an example of a format of an address notification message using a BU message according to the third embodiment of the present invention.

### BEST MODE FOR CARRYING OUT THE INVENTION

Embodiments of the present invention will hereinafter be described with reference to the drawings.

### First Embodiment

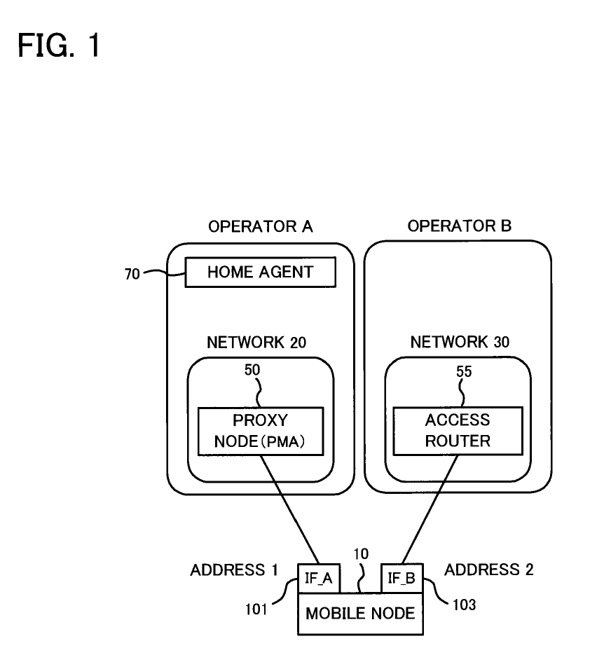

First, a first embodiment of the present invention will be described. FIG. 1 is a diagram of an example of a network configuration according to the first embodiment of the present invention. In FIG. 1, a network 20 implementing a network-based mobility protocol and a network 30 not implementing a network-based mobility protocol are present. An example of the network-based mobility protocol is PMIPv6, described in Non-patent Document 2.

A proxy node 50 and a home agent 70 that are constituent elements in the network-based mobility protocol are located in the network 20. The proxy node 50 is referred to as a proxy mobile agent (PMA, or mobile access gateway [MAG]) when PMIPv6 is used. The home agent 70 is referred to as a proxy mobile anchor (LMA). The network-based mobility protocol is not operating in the network 30. The network 30 is, for example, an ordinary IPv6 network in which an access router 55 is located.

A mobile node (MN) 10 is a user terminal that has two interfaces. An address 1 is assigned to one interface (IF_A101) of the MN 10. The IF_A101 is connected to the network 20. An address (address 2) differing from the address 1 is assigned to the other interface (IF_B103) of the MN 10. The IF_B103 is connected to the network 30.

According to the first and second embodiments of the present invention, the user terminal is referred to as a MN (mobile node). However, although the user terminal can move between different networks, the user terminal itself is not required to implement a mobility management protocol, such as mobile IPv6. In Non-patent Document 2, a user terminal that is connected to a network in which the network-based mobility protocol is operating and does not itself implement a mobility management protocol is referred to as a mobile station or a mobility station. Like the mobile station and the mobility station, the MN according to the first and second embodiments of the invention does not provide a mobility management function. On the other hand, the MN according to the first and second embodiments of the present invention has a plurality of interfaces and provides a function for managing a plurality of care-of addresses.

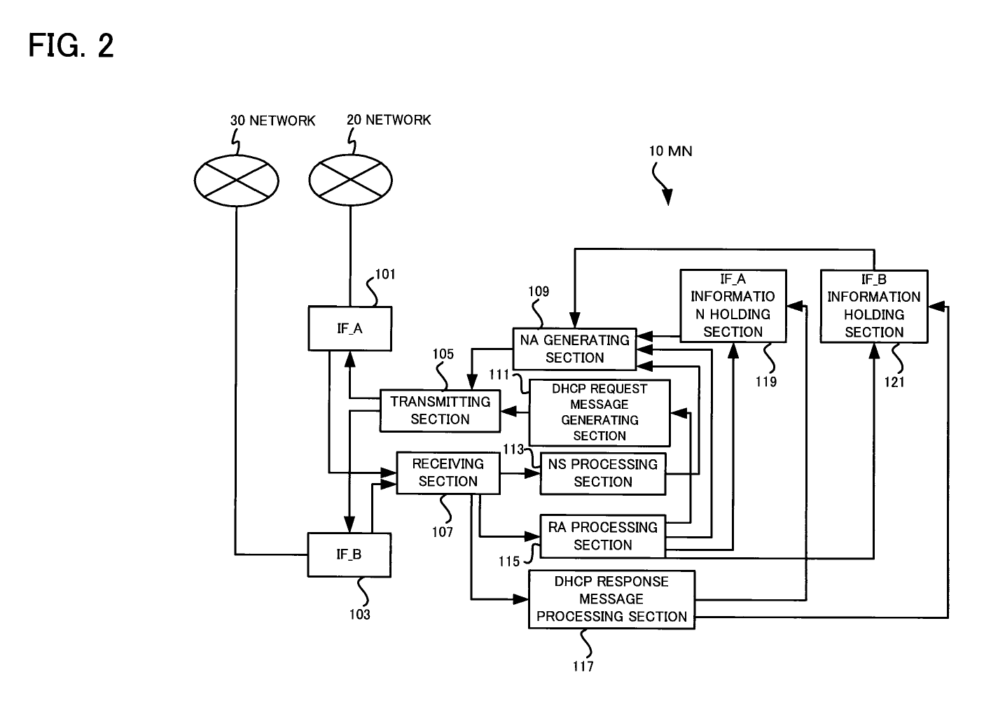

Next, constituent elements of the MN 10 shown in FIG. 1 will be described. FIG. 2 shows an example of a configuration of a mobile node according to the first embodiment. The MN 10 includes two interfaces (IF_A and IF_B) 101 and 103, a transmitting section 105, a receiving section 107, an NA generating section 109, a DHCP request message generating section 111, an NS processing section 113, an RA processing section 115, a DHCP response message processing section 117, an IF_A information holding section 119, and an IF_B information holding section 121.

The IF_A 101 and the IF_B 103 are two interfaces provided on the MN 10. The IF_A 101 and the IF_B 103 are each connected to the transmitting section 105 and the receiving section 107. Packets are transmitted and received via the network 20 and the network 30 to which the IF_A 101 and the IF_B 103 are respectively connected. The MN 10 is a mobile terminal that can be carried by a user. The IF_A 101 and the IF_B 103 are preferably wireless communication interfaces.

The transmitting section 105 provides a function for receiving instructions from the NA generating section 109 and the DHCP request message generating section 111, and transmitting messages received from the NA generating section 109 and the DHCP request message generating section 117 from a designated IF (the IF_A 101 or the IF_B 103). The transmitting section 105 also transmits data packets transmitted from the MN 10 (not shown in FIG. 2).

The receiving section 107 provides a function for receiving messages from the IF_A 101 and the IF_B 103, and sending the received messages to the NS processing section 113, the RA processing section 115, and the DHCP response message processing section 117, based on the type of message received. The receiving section 107 also appropriately processes data packets received from another communication device, such as by sending the data packet to an upper layer (not shown in FIG. 2).

The NA generating section 109 generates a neighbor advertisement (NA) message including an address of the IF_A 101, held by the IF_A information holding section 119, in a target address field and a link layer address of the IF_A 101 as an option, based on an instruction from the NS processing section 113 or the RA processing section 115, or judgment by the NA generating section 109 itself. The NA generating section 109 then instructs the transmitting section 105 to transmit the generated NA message to the network 20 to which the IF_A 101 is connected.

In a similar manner, the NA generating section 109 generates an NA message including an address of the IF_B 103, held by the IF_B information holding section 121, in a target address field and a link layer address of the IF_B 103 as an option, based on an instruction from the NS processing section 113 or the RA processing section 115, or judgment by the NA generating section 109 itself. The NA generating section 109 then instructs the transmitting section 105 to transmit the generated NA message to the network 30 to which the IF_B 103 is connected. For example, a unicast address of a transmission source node of a neighbor solicitation (NS) message requesting transmission of the NA message is preferably set as the destination of the NA message. However, the destination can also be an all-nodes multicast address or an all-routers multicast address.

The NA generating section 109 also generates an NA message for giving notification of an address of an interface other than the interface that has received the NS message, based on an instruction from the NS processing section 113 or judgment by the NA generating section 109 itself. The NA generating section 109 then instructs the transmitting section 105 to transmit the generated NA message from the interface that has received the NS message. The NA generating section 109 can also generate an NA message for giving notification of an address of a certain interface regardless of the reception of the NS message, based on judgment by the NA generating section 109 itself or the like. The NA generating section 109 can then instruct the transmitting section 105 to transmit the generated NA message from another interface.

In a similar manner, the NA generating section 109 generates an NA message including an address of an interface other than the interface that has received a router advertisement (RA) message, based on an instruction from the RA processing section 115 or judgment by the NA generating section 109 itself. The NA generating section 109 then instructs the transmitting section 105 to transmit the generated NA message from the interface that has received the RA message. The NA generating section 109 can also generate an NA message for giving notification of an address of a certain interface regardless of the reception of the RA message, based on judgment by the NA generating section 109 itself or the like. The NA generating section 109 can then instruct the transmitting section 105 to transmit the generated NA message from another interface.

As an address notification method, a method can be considered in which notification is given by the address of the other interface being included as an option within an ordinary NA message generated as a result of a reception process performed for an ordinary NS message. Alternatively, for example, a method can be considered in which notification is given by an NA message other than the ordinary NA message generated as a result of the reception process performed on the ordinary NS message being generated, and the address of the other interface being included as an option within the other NA message.

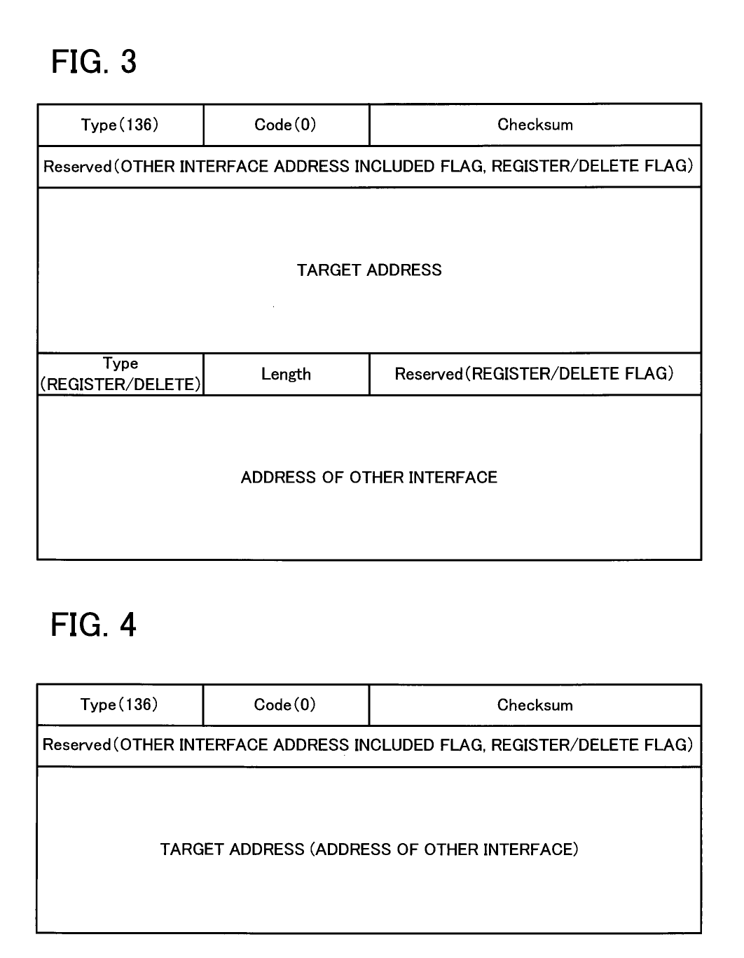

In the former address notification method, the option including the address of the other interface can be added to the NA message, for example, as an option such as that shown in FIG. 3. Alternatively, a pre-existing option can be used. In the NA message (type 136) shown in FIG. 3, an address assigned to the interface that transmits the NA message is entered into the target address field. The address of the other interface is entered into the option. The NA message is effective when, for example, the received NS message is a message requesting the link layer address of the interface transmitting the NA message and a message for giving notification of information requesting the address of the other interface (also referred to, hereinafter, as other IF address request information). In this instance, an option including the link layer address of the interface transmitting the NA message is added to the NA message in FIG. 3 (not shown).

On the other hand, in the latter address notification method, the MN 10 can give notification of the address of the other interface by, for example, including the address of the other interface in the target address field of the NA message, as shown in FIG. 4. The NA message is effective when, for example, the received NS message is a message for giving notification of information requesting only the address of the other interface (also referred to, hereinafter, as other IF address request information). In this instance, an option including the link layer address of the interface transmitting the NA message can be added to the NA message in FIG. 4 (not shown).

In the NA messages including the address of the other interface, shown in FIG. 3 and FIG. 4, information indicating that the NA message includes the address of the other interface (other interface address-included flag) can be set as a flag in, for example, a reserved field of the NA message.

When the MN 10 transmits an NA message to request use of the address of the other interface as a transfer destination, the MN 10 can include information indicating a request for registration of the address of the other interface within the NA message. In this instance, the other interface address registration request can be indicated, for example, by a flag in an option type field in which the address of the other interface is entered or the reserved field, shown in FIG. 3. Alternatively, the other interface address registration request can be indicated, for example, by a value in a code field or a flag in the reserved field of the NA message shown in FIG. 3 and FIG. 4.

In addition to registration of the address of the other interface, the MN 10 can also transmit an NA message for giving notification of termination of use of the address of the other interface as the transfer destination. The MN 10 can include information indicating a request to delete registration of the address of the other interface within the NA message. In this instance as well, the other interface address registration deletion request can be indicated, for example, by a flag in the option type field in which the address of the other interface is entered or the reserved field, shown in FIG. 3. Alternatively, the other interface address registration deletion request can be indicated, for example, by a value in the code field or a flag in the reserved field of the NA message shown in FIG. 3 and FIG. 4.

A specific process is as follows. When the MN 10 is connected to the network 20 by the IF_A 101 and connected to the network 30 by the IF_B 103, the NS processing section 113 receives an NS message including the other IF address request information or an NS message including information (IsPMIP information) indicating that the network 20 is implementing the network-based mobility protocol, from the network 20 implementing the network-based mobility protocol. The NS processing section 113 processes the NS message. When the NA generating section 109 receives an instruction from the NS processing section 113 to generate and transmit an NA message including the address of the other interface, the NA generating section 109 acquires the address of the IF_B 103 from the IF_B information holding section 121 and generates an NA message including the acquired address. The NA generating section 109 then instructs the transmitting section 105 to transmit the generated NA message to the network 20 to which the IF_A 101 is connected.

When the RA processing section 115 receives an RA message including the other IF address request information from the network 20 or an RA message including information (IsPMIP information) indicating that the network 20 is implementing the network-based mobility protocol, in a similar manner, the RA processing section 115 instructs the NA generating section 109 to generate an NA message including the address of the IF_B 102. The NA generating section 109 then instructs the transmitting section 105 to transmit the generated NA message to the network 20 to which the IF_A 101 is connected. A unicast address of the transmission source of the NS message or the RA message (such as a proxy node A in FIG. 1) is preferably set as the destination of the NA message. However, an all-nodes multicast address or an all-routers multicast address can also be. As a method of determining whether a connected network is implementing the network-based mobility protocol, the network can be determined to be implementing the network-based mobility protocol when a advertised prefix within the RA message is a home prefix of the MN 10 itself or when an assigned address (configured/acquired in a stateless or stateful manner) is the home address of the MN 10 itself.

The DHCP request message generating section 111 receives an instruction from the RA processing section 115 and generates a DHCP request message for acquiring the addresses assigned to the IF_A 101 and the IF_B 103. The DHCP request message generating section 11 then sends the generated DHCP request message to the transmitting section 105 and instructs the transmitting section 105 to transmit the generated DHCP request message. The MN 10 can acquire the addresses assigned to the IF_A 101 and the IF_B 103, for example, by operations performed by the DHCP request message generating section 111 and the DHCP response message processing section 117. However, the MN 10 is not necessarily required to acquire the address using the DHCP. The MN 10 can use an arbitrary address acquiring method (such as address autoconfiguration).

The NS processing section 113 processes the NS messages received from the network 20 to which the IF_A 101 is connected and the network 30 to which the IF_B 103 is connected. When an address included in the target address field within the NS message is the address of the MN 10 itself, the NS processing section 113 instructs the NA generating section 109 to generate an NA message including a link layer address of the IF to which the address is assigned.

When the received NS message includes information (other IF address request information) requesting the address of an interface other than the interface that has received the NS message and/or information (IsPMIP information) indicating that the network 20 is implementing the network-based mobility protocol, the MN 10 instructs the NA generating section 109 to generate an NA message including the address assigned to the interface other than the interface that has received the NS message, among the interfaces on by the MN 10 itself, and transmit the generated NA message from the interface than has received the NS message. When the other IF address request information or the IsPMIP information is set in the NS message, the other IF address request information or the IsPMIP information is indicated to the MN 10 by a value in the code field or a flag in the reserved field.

The RA processing section 115 processes RA messages received from the network 20 to which the IF_A 101 is connected and the network 30 to which the IF_B 103 is connected. When the RA message includes the other IF address request information requesting the address of the interface other than the interface that has received the RA message and/or the information (IsPMIP information) indicating that the network 20 is implementing the network-based mobility protocol, the RA processing section 115 instructs the NA generating section 109 to generate an NA message including the address of the interface other than the interface that has received the RA message. The RA processing section 115 then instructs the NA generating section 109 to transmit the generated NA message from the interface that has received the RA message. The other IF address request information or the IsPMIP information is indicated, for example, by use of a flag in the reserved field of the RA message.

The DHCP response message processing section 117 processes a DHCP response message generated in response to a DHCP request message transmitted by the DHCP request message generating section 111. The DHCP response message processing section 117 acquires an address included in the DHCP response message, and instructs the IF_A information holding section 119 or the IF_B information holding section 121 to assign the acquired address to the interface that has received the DHCP response message.

The IF_A information holding section 119 holds the address received from the RA processing section 115 or the DHCP response message processing section 117 as the address assigned to the IF_A 101. The IF_A information holding section 119 sends the address assigned to the IF_A 101 when a request is received from the NA generating section 119.

The IF_B information holding section 121 holds the address sent from the RA processing section 115 or the DHCP response message processing section 117 as the address assigned to the IF_B 103. The IF_B information holding section 121 sends the address assigned to the IF_B 103 when a request is received from the NA generating section 119.

According to the first embodiment of the present invention, the NA message is used as a message by which the MN 10 gives notification of an address of one interface to a network to which another interface is connected. However, an arbitrary message can be used (such a control message based on IEEE 802.21 that is a standard actualizing a seamless handover between wireless terminals). A message used in layer 2 can also be used in place of the NA message. For example, notification of the address of the other interface can be given using a message exchanged between a base station and a terminal used in a cellular network.

As described above, the MN 10 according to the first embodiment has a plurality of interfaces. The address of another interface can be inserted into a notification message transmitted from one interface.

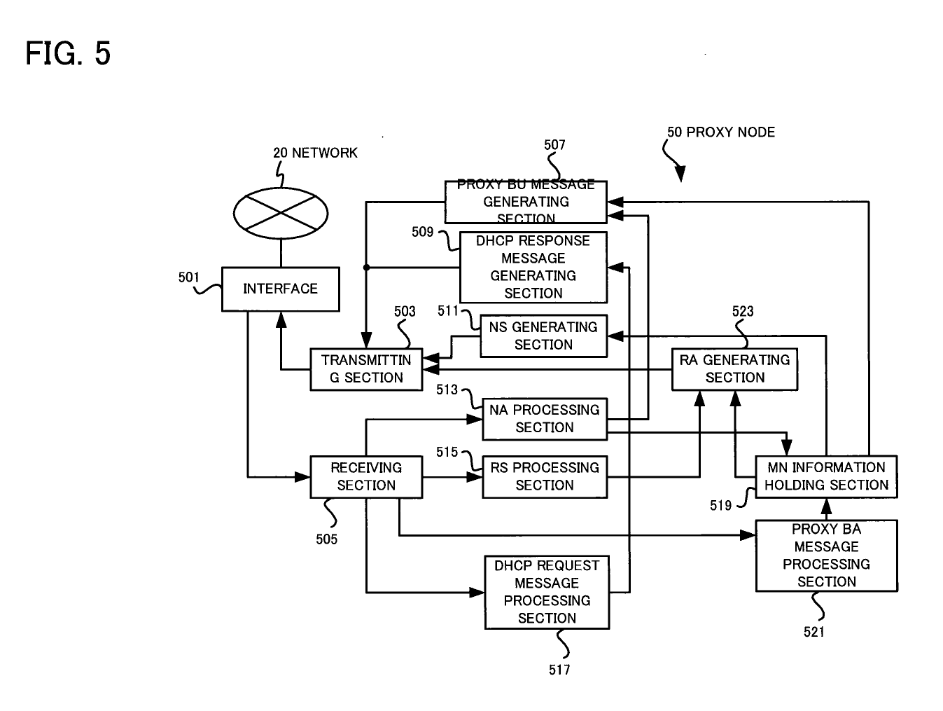

Next, constituent elements of a proxy node shown in FIG. 5 will be described. FIG. 5 is a diagram of an example of a configuration of a proxy node according to the first embodiment of the present invention. The proxy node 50 shown in FIG. 5 includes an interface 501, a transmitting section 503, a receiving section 505, a proxy BU message generating section 507, a DHCP response message generating section 509, an NS generating section 511, an NA processing section 513, an RS processing section 515, a DHCP request message processing section 517, an MN information holding section 519, a proxy BA message processing section 521, and an RA generating section 523.

The interface 501 is a communication interface provided on the proxy node 50. In the network configuration shown in FIG. 1, the interface of the proxy node 50 is connected to the network 20. The interface 501 is connected to the transmitting section 503 and the receiving section 505. Packets are transmitted and received via the network 20.

The transmitting section 503 and the receiving section 505 provide functions for allowing the proxy node 50 to exchange packets with an external communication device via the network 20.

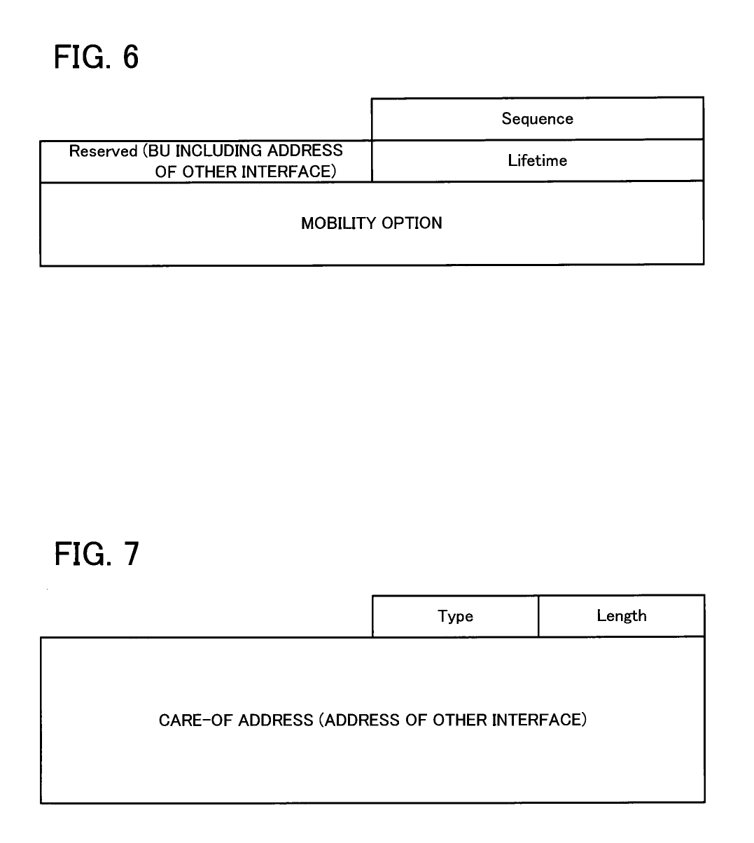

The proxy BU message generating section 507 receives an instruction from the NA processing section 513 and generates a proxy BU message including a received address as a care-of address. The proxy BU message generating section 507 then instructs the transmitting section 503 to transmit the generated proxy BU message to the home agent. In addition, the proxy BU message generating section 507 can indicate information stating that the address to be registered by the proxy BU message is the address of the other interface of the MN 10 and not the ordinarily registered address of the proxy node 50 using, for example, a flag in a reserved field of the proxy BU message shown in FIG. 6. The proxy BU message generating section 507 can also insert the address of the other interface in a proxy BU message option in which a new type is set as shown in FIG. 7, and add the option to the proxy BU message.

When the instruction from the NA processing section 513 indicates registration of the address, the proxy BU message generating section 507 generates a proxy BU message for registering the received address as the care-of address. The proxy BU message generating section 507 then sends the generated proxy BU message to the transmitting section 503 and instructs the transmitting section 503 to transmit the generated proxy BU message. On the other hand, when the instruction from the NA processing section 513 indicates deletion of the address, the proxy BU message generating section 507 generates a proxy BU message for deleting a registered entry of the received address. The proxy BU message generating section 507 then sends the generated proxy BU message to the transmitting section 503 and instructs the transmitting section 503 to transmit the generated proxy BU message. The proxy BU message in this instance includes the home address in the area including the address indicating the care-of address.

The proxy BU message generating section 507 can add a BID to the proxy BU message including the address of the other interface of the MN 10. The BID is added to differentiate between an already registered binding cache and a binding cache to be registered.

The DHCP response message generating section 509 receives an instruction from the DHCP request message processing section 517 and generates a DHCP response message including the address assigned to the MN 10 as a response message for the DHCP message received from the MN 10. The DHCP response message generating section 509 then instructs the transmitting section 505 to transmit the generated DHCP response message.

The NS generating section 511 generates an NS message including the address of the MN 10 as the target address to, for example, determine a link layer address for the address assigned to the IF_A 101 of the MN 10. Ordinarily, the NS message is used to acquire a layer 2 address required to transmit a packet destined for a node present on the same link. In this instance, the NS message is transmitted to a node having the address included in the target address field to request the link layer address of the interface to which the address is assigned.

The NS generating section 511 can include information indicating that the network 20 is implementing the network-based mobility protocol (IsPMIP information) and information requesting the address assigned to the interface other than the interface that receives the generated NS message (other IF address request information) in the NS message. The IsPMIP information and the other IF address request information can be inserted into the NS message transmitted to determine the link layer address of the IF_A 101 of the MN 10 described above. Alternatively, an NS message can be generated including only the other IF address request information.

The NS message in this instance functions as a message used only to request the address assigned to the interface other than the interface receiving the NS message.

When the other ID address request information is included within the ordinary NS message, the receiving node (the MN 10 receiving the NS message) performs a reception process for an ordinary NS message. In addition, the receiving node performs a process for giving notification of the address of the interface other than the interface that has received the NS message to the transmitting source of the NS message as a process performed on the other IF address request information.

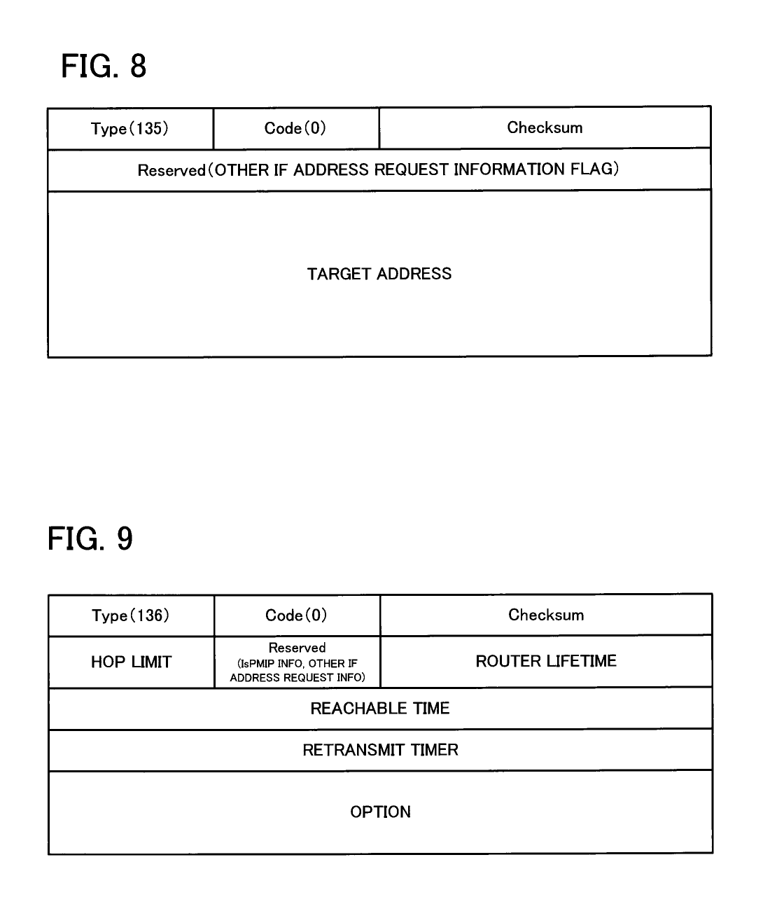

The other IF address request information can be indicated by a value in the code field or a flag in the reserved field of the NS message, as shown in FIG. 8. In addition, the other IF address request information can be actualized as a new option added to the NS message. The NS message can be transmitted at an arbitrary timing including the other IF address request information, regardless of the timing at which the layer 2 address of the destination node is acquired.

The NA processing section 513 performs a process related to the NA message received from the MN 10. The NA processing section 513 instructs the MN information holding section 519 to hold the address of the MN 10 included in the received NA message.

Moreover, when the address in the target address field of the NA message is the home address and the address of the other interface is included as an option, the NA processing section 513 identifies the MN 10 using the home address included in the target address field as a key. The NA processing section 513 then instructs the MN information holding section 519 to hold the address included in the option of the NA message as the address of the other interface of the MN 10. When the address of the other interface is included in the target address field, the NA processing section 513 identifies the MN 10 using a transmission source address of the message and the link layer address included in the option within the message as keys. The NA processing section 513 then instructs the MN information holding section 519 to hold the address within the target address field as the address of the other interface of the MN 10. The MN 10 can also be identified by a combination of the home address and the link layer address of the MN 10. Alternatively, another MN 10 identifier can be used. As in the NA messages shown in FIG. 3 and FIG. 4, when an other interface address-included flag indicating that the address of the other interface is included is included, based on this information, whether the NA message is an ordinary NA message or a special NA message giving notification of the address of the other interface can be determined.

When an address included within the received NA message is the address of the other interface of the MN 10 (namely an address other than the home address), the NA processing section 513 instructs the proxy BU message generating section 507 to generate a proxy BU message including the address of the other interface of the MN 10 as the care-of address.

When the NA message received from the MN 10 is the NA message for giving notification of the address of the other interface of the MN 10, for example, in the network configuration shown in FIG. 1, the NA message includes the address of the IF_B 103 of the MN 10. When registration request information indicating registration of the address of the other interface is included in the NA message, the NA processing section 513 instructs the proxy BU message generating section 507 to generate a proxy BU message for registering the address of the IF_B 103 of the MN 10 at the home agent as the care-of address. On the other hand, when deletion request information indicating deletion of the address is included, the NA processing section 513 instructs the proxy BU message generating section 507 to generate a proxy BU message for deleting the address of the other interface from the home agent.

The RS processing section 515 performs a process related to a router solicitation (RS) message received from the MN 10 and instructs the RA generating section 523 to generate an RA message as a response message.

The DHCP request message processing section 517 performs a process related to the DHCP request message received from the MN 10, and instructs the DHCP response message generating section 509 to generate a DHCP response message including the home address of the MN 10.

The MN information holding section 519 associates the address of the other interface of the MN 10 received from the NA processing section 513 with the home address and the link layer address of the MN 10 and holds the associated addresses.

The proxy BA message processing section 512 processes a proxy BA message that is a response to the proxy BU message transmitted by the proxy BU message generating section 507. The proxy BA message processing section 512 acquires a result indicating whether the location information of the MN 10 of which notification has been given (the address of the proxy node 50 or the address of the other interface) is registered as the care-of address or whether the location information has been deleted. When the address of the proxy node 50 is registered as the care-of address, the proxy BA message processing section 521 instructs the RA generating section 523 to transmit an RA message including a home prefix of the MN 10. After the proxy BA message processing section 512 receives the proxy BA message, the proxy BA message processing section 512 can give an instruction for transmission of an NS message, an NA message, or an RA message including the result indicating whether the address of the other interface of the MN 10 is registered or has been deleted (not shown).

The RA generating section 523 can include information indicating that the network 20 is implementing the network-based mobility protocol (IsPMIP information) and information requesting the address assigned to the interface other than the interface that receives the generated RA message (other IF address request information) in the RA message. The IsPMIP information and the other IF address request information can be inserted into an ordinary RA message used to transmit router information to the MN 10. Alternatively, an RA message including only the IsPMIP information and the other IF address request information can be generated.

As shown in FIG. 9, the above-described IsPMIP information and the other IF address request information can be indicated by a value in the code field or a flag in the reserved field of the RA message. The RA message in this instance functions as a message used only to request, from the MN 10 that receives the RA message, the address assigned to the interface other than the interface that has received the RA message.

The IsPMIP information and the other IF address request information can be indicated by a same piece of information. When the other IF address request information is included within an ordinary RA message, the receiving node (the MN 10 receiving the RA message) performs a reception process for an ordinary RA message. In addition, the receiving node performs a process for giving notification of the address of the interface other than the interface that has received the RA message to the transmitting source of the RA message as a process performed on the other IF address request information.

As described above, the proxy node 50 according to the first embodiment can know the address of another interface not being used to connect with the proxy node 50, among the plurality of interfaces on the MN 10. The proxy node 50 can perform a proxy BU on the home agent performing the movement management of the MN 10, using the address of the other interface.

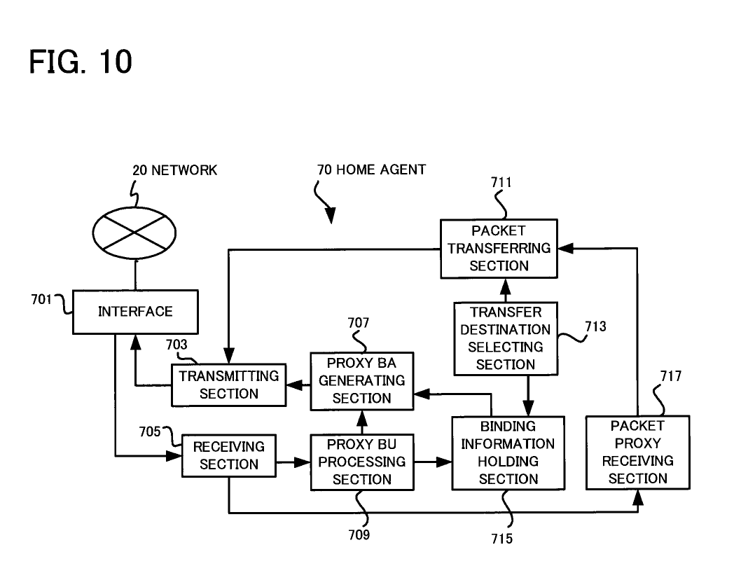

Next, constituent elements of the home agent shown in FIG. 10 will be described. In FIG. 10, an example of a configuration of a home agent according to the first embodiment of the present invention is shown. A home agent 70 shown in FIG. 10 includes an interface 701, a transmitting section 7-3, a receiving section 705, a proxy BA generating section 707, a proxy BU processing section 709, a packet transmitting section 711, a transfer destination selecting section 713, a binding information holding section 715, and a packet proxy receiving section 717.

The interface 701 is a communication interface provided on the home agent 70. In the network configuration shown in FIG. 1, the interface of the home agent 70 is connected to the network 20. The interface 701 is connected to the transmitting section 703 and the receiving section 705. Packets are transmitted and received via the network 20.

The transmitting section 703 and the receiving section 705 provide functions for allowing the home agent 70 to exchange packets with an external communication device via the network 20.

The proxy BA generating section 707 receives an instruction from the proxy BU processing section 709 and generates a proxy BA message as a response message for a proxy BU message. The generated proxy BA message includes the address of the proxy node 50 or a registration result of the address of the other IF. The proxy BA generating section 707 then instructs the transmitting section 703 to transmit the generated proxy BA message.

The proxy BU processing section 709 processes the proxy BU message received from the proxy node 50. When the proxy BU message includes information indicating that the BU is for other IF address registration, the proxy BU processing section 709 instructs the binding information holding section 715 to hold the address of the other interface included in the proxy BU message as the location information of the MN 10 to be registered. When a BID is added to the proxy BU message, the proxy BU processing section 709 instructs the binding information holding section 715 to hold the address of the other interface with the BID. Moreover, the proxy BU processing section 709 instructs the proxy BA generating section 707 to generate a proxy BA message as a response message for the received proxy BU message.

The packet transferring section 711 serves to transfer a packet received from the packet proxy receiving section 717 to the MN 10. The packet transferring section 711 instructs the transfer destination selecting section 713 to select a transfer destination of the MN 10. The packet transferring section 711 instructs the transmitting section 703 to transmit the packet to which a header has been added and that has been encapsulated. The header sets the transfer destination of which notification has been given from the transfer destination selecting section 713 as the destination.

The transfer destination selecting section 713 receives an instruction from the packet transfer section 711. The transfer destination selecting section 713 references the binding information holding section 715, selects a transfer destination of the MN 10 that is the destination of the packet that has been received by proxy, and responds to the packet transferring section 711 with the selected transfer destination. When the address of the other interface of the MN 10 is registered as the transfer destination (care-of address) of the MN 10 in addition to the ordinary proxy node 50 address, either address can be used as the transfer destination. When the flow information is registered by the MN 10, the transfer destination to be used can be switched accordingly, based on flow information corresponding to the data to be transferred.

The binding information holding section 715 holds the location information of the MN 10 received from the proxy BU processing section 709. When the address of the other interface of the MN 10 is held, information indicating that the address is the address of the other interface of the MN 10 is added to the binding cache.

The packet proxy receiving section 717 receives a packet addressed to the home address of the MN 10 managed by the binding information holding section 715, and sends the packet to the packet transferring section 711.

As described above, the home agent 70 according to the first embodiment of the present invention can update the binding cache entry of the MN 10 based on the proxy BU message from the proxy node 50. As a result of the address of the other interface of the MN 10 being registered as the transfer destination of the packet destined for the MN 10, the packet destined for the MN 10 can be transferred to the other interface of the MN 10. Moreover, because the home agent 70 can select either the address of the proxy node 50 or the address of the other interface of the MN 10 accordingly as the transfer destination of the packet destined for the MN 10, appropriate flow filtering can be actualized.

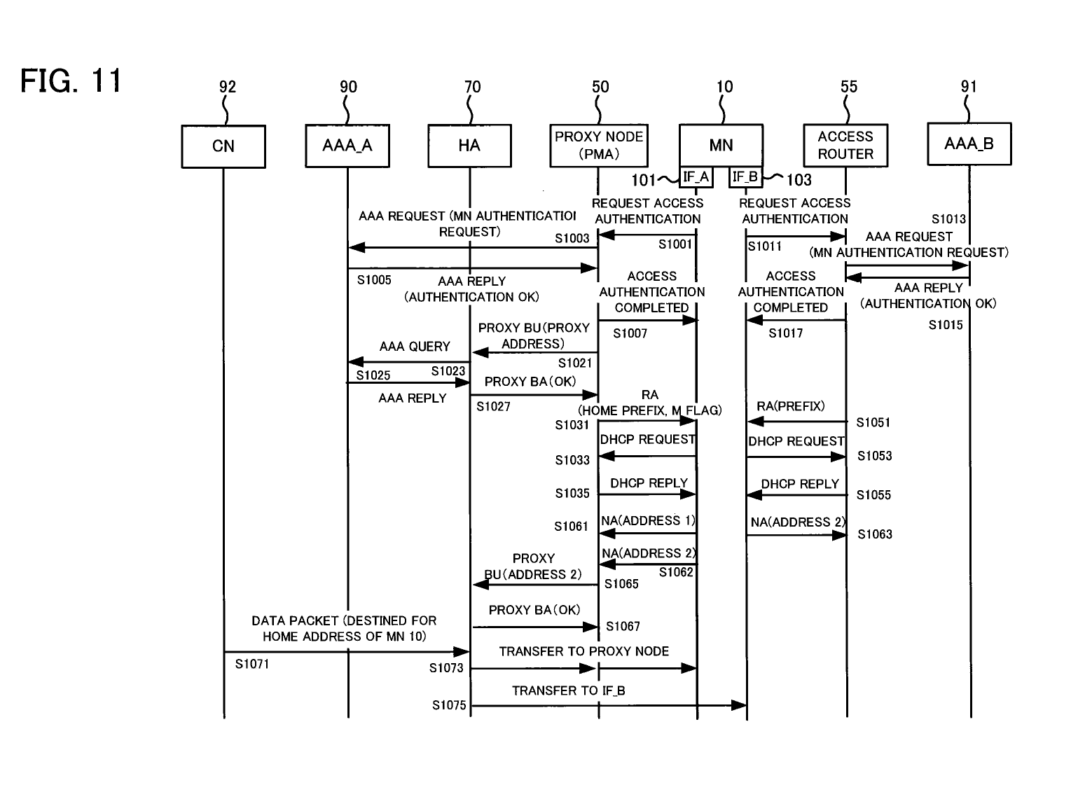

Next, operations according to the first embodiment of the present invention will be described. FIG. 11 is a sequence chart of an example of operations performed in the overall system according to the first embodiment of the present invention.

In FIG. 11, the IF_A 101 of the MN 10 transmits an access authentication request to the network 20 for establishing connection to the network 20 (the proxy node 50) (Step S1001). The proxy node 50 makes a query regarding the authentication to an authentication server (AAA_A) 90 of an operator A (Step S1003: AAA request). When a response giving notification of authorization is received (Step S1005: AAA reply), the proxy node 50 responds to the MN 10 with access authentication completed (Step S1007).

On the other hand, when the IF_B 103 of the MN 10 accesses the network 30 in which the network-based mobility protocol is not operating, the access router 55 performs access authentication in a similar manner, (Step S1011 to Step S1017).

Then, in the network 20, based on the operation of the network-based mobility protocol, the proxy node 50 transmits a proxy BU message to the home agent 70 such that, for example, the packet destined for the MN_A 101 is transferred to the proxy node 50 or a certain anchor point (Step S1021). After the home agent 70 receives authorization from the AAA_A 90 (Step S1023 and Step S1025), the home agent 70 transmits a proxy BA message in response to the proxy BU message (Step S1027).

Then, the proxy node 50 transmits an RA message to the MN 10 in the network 20 (Step S1031). The RA message includes a home prefix. An M flag prompting stateful autoconfiguration of the address is set in the RA message. The MN 10 transmits a DHCP request message to the proxy node 50 (Step S1033), and receives a DHCP response message from the proxy node 50 in response (Step S1035). As a result, the MN 10 acquires the address 1 set on the IF_A 101. In a similar manner, the address 2 is acquired for the IF_B 103 using, for example, the DHCP (Step S1051 to Step S1055).

Then, an NA message including the address 1 is transmitted from the IF_A 101 of the MN 10 in a response to the NS message from the proxy node 50, by being voluntarily transmitted by the MN 10, and the like (Step S1061). Regarding the address 2 set on the IF_B 103 as well, an NA message including the address 2 is transmitted from the IF_A 101 of the MN (Step S1062). As described above, the address 1 and the address 2 can be transmitted by a same NA message or by different NA messages.

As a result, the MN 10 knows that the address 2 is set on the other IF_B 103, in addition to the address 1 being set on the IF_A 101. The proxy node 50 transmits a proxy BU message including the address 2 to the home agent 70 (Step S1065), and receives a proxy BA message indicating that the address has been registered (Step S1067).

As a result, for example, regarding a data packet transmitted from a correspondent node (CN) 90 to the home address of the MN 10 (Step S1071), the home agent 70 can tunnel the data packet to the proxy node 50 such that the data packet reaches the IF_A 101. The home agent 70 can also tunnel the data packet directly to the IF_B 103. Therefore, as a result of appropriate flow filtering being applied, the MN 10 can receive a desired data packet flow using the desired interface between the two interfaces (IF_A 101 and IF_B 103).

Because the network-based mobility protocol is not operating in the network 30 to which the IF_B 103 is connected, the network 30 is not required to be notified of the address 1 set on the other IF_A 101. Therefore, notification by the NA message from the IF_B 103 is merely required to be performed for the address 2 set on the IF_B 103, as is ordinarily required (Step S1063).

As described above, according to the first embodiment of the present invention, the address of the interface (IF_B 103) not connected to the network 20 that implements the network-based mobility protocol can be registered at the home agent 70 without the MN 10 knowing the address of the home agent 70. Both the interface (IF_A 101) connected to the network 20 implementing the network-based mobility protocol and the interface (IF_B 103) connected to the other network 30 can be used to transmit and receive packets. Flow control can be performed.

### Second Embodiment

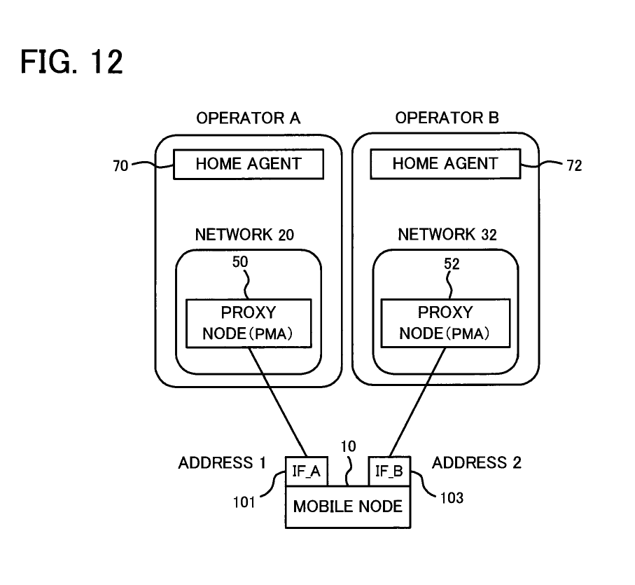

Next, a second embodiment of the present invention will be described. FIG. 12 is a diagram of an example of a network configuration according to the second embodiment of the present invention.

According to the first embodiment of the present invention described above, the two interfaces (IF_A 101 and IF_B 103) of the MN 10 are respectively connected to the network 20 implementing the network-based mobility protocol and the network 30 not implementing the network-based mobility protocol. However, here, as shown in FIG. 12, the interfaces (IF_A 101 and IF_B 103) of the MN 10 are respectively connected to the network 20 and a network 32 both implementing the network-based mobility protocol. In a manner similar to the network 20 side, a proxy node 52 and a home agent 72 are located on the network 32 side.

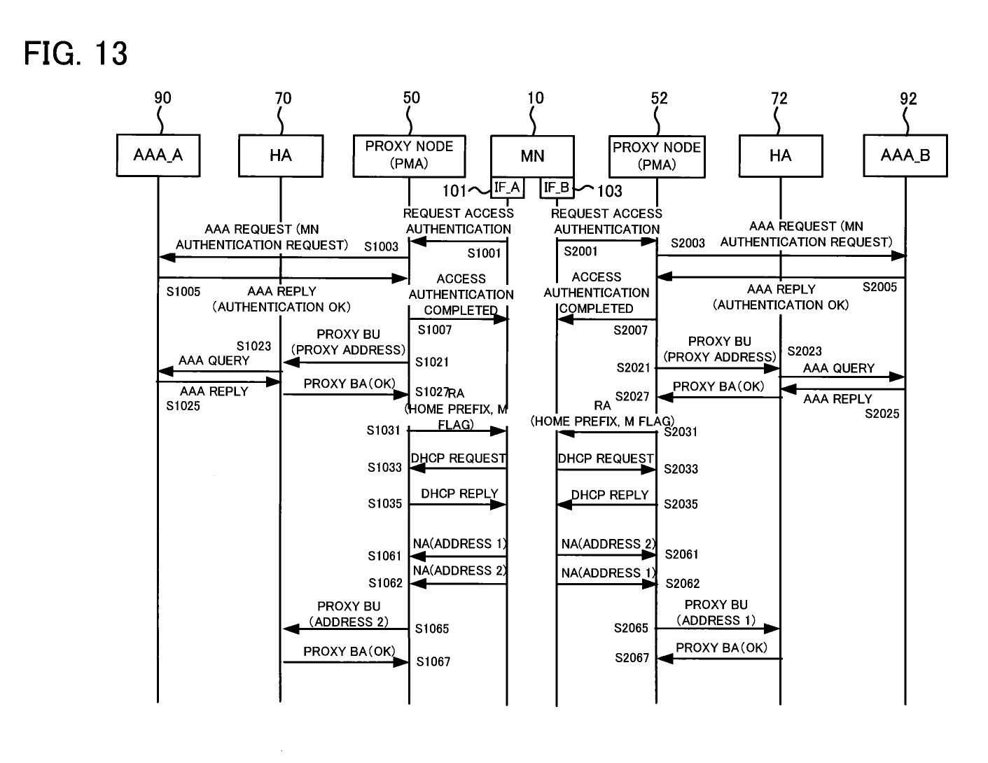

FIG. 13 is a sequence chart of an example of operations performed by the overall system according to the second embodiment of the present invention. As is clear from the network configuration in FIG. 12, according to the second embodiment of the present invention, the two interfaces (IF_A 101 and IF_B 103) of the MN 10 are respectively connected to comparable networks 20 and 32 in which the network-based mobility protocol is operating. Therefore, the processes performed in the network to which the IF_A 101 is connected and the processes performed in the network 32 to which the IF_B 103 is connected are basically the same.

In FIG. 13, the processes at Step S1001 to Step S1067 (processes performed in the network 20 to which the IF_A 101 is connected) are the same as those at the steps in FIG. 12 having the same reference numbers. Explanations thereof are omitted. On the other hand, the network 32 to which the IF_B 103 is connected is also given notification of the address 1 set on the IF_A 101 (Step S2062), in addition to the address 2 set on the IF_B 103 (Step S2061). As a result, both the address 1 and the address 2 are also registered at the home agent 72 located on the network 32 by proxy BU from the proxy node 50 (Step S2065). In a similar manner as the home agent 70 located on the network 20, either the IF_A 101 or the IF_B 103 can be selected as the transfer destination of the packet destined for the MN 10.

Technology related to the first and second embodiments of the present invention can also be applied to a mobile terminal supporting a host-based mobility protocol. In this instance, the mobile terminal can operate by selecting the network-based mobility protocol having a lighter processing load, instead of the host-based mobility protocol.

### Third Embodiment

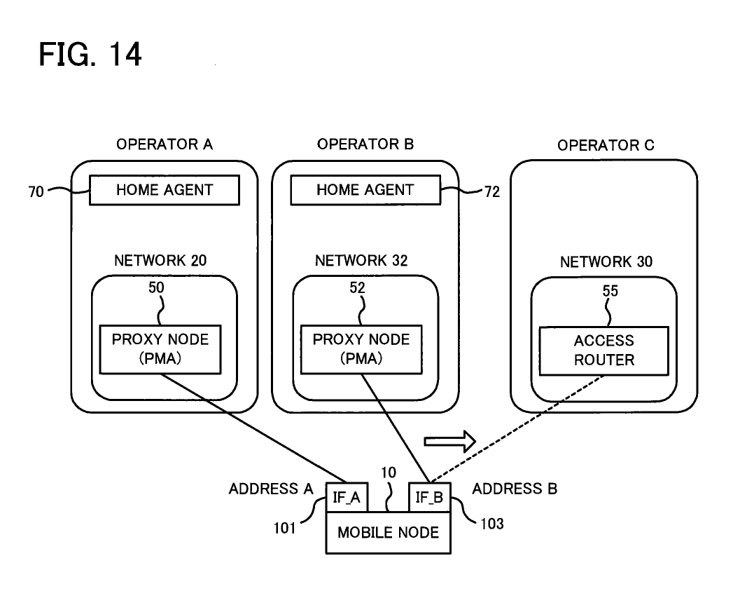

Next, a third embodiment of the present invention will be described. FIG. 14 is a diagram of an example of a network configuration according to the third embodiment of the present invention.

In FIG. 14, the network 20 and the network 32 implementing the network-based mobility protocol, and the network 30 not implementing the network-based mobility protocol are present. Here, the network-based mobility protocol is assumed to be PMIPv6 described in Non-patent Document 2.

The proxy node 50 and the home agent 70 that are constituent elements in PMIPv6 are located in the network 20. The proxy node 52 and the home agent 72 are similarly located in the network 32. Here, the network 20 and the network 32 are home networks implementing PMIPv6. The proxy node 50 and the proxy node 52 advertise the home prefix of the MN 10. The proxy node 50 and the proxy node 52 are referred to as a PMA or a MAG in PMIPv6. The home agent 70 and the home agent 72 are referred to as a LMA. On the other hand, the PMIPv6 is not operating in the network 30. The network 30 is, for example, an ordinary IPv6 network. The access router 55 is located in the network 30.

The mobile node (MN) 10 is a user terminal that has two interfaces. An address 1 is assigned to one interface (IF_A 101) of the MN 10. The IF_A 101 is connected to the network 20. An address (address 2) differing from the address 1 is assigned to the other interface (IF_B103) of the MN 10. The IF_B103 is connected to the network 32. The MN 10 uses at least the address 1 as its home address.

According to the above-described second embodiment of the present invention, the two interfaces (IF_A 101 and IF_B 103) of the MN 10 are respectively connected to the network 20 and the network 32 implementing the PMIPv6. However, according to the third embodiment, an instance is considered in which the IF_B 103 connected to the network 32 performs a handover and connects to the network 30 that does not implement PMIPv6.

Moreover, the MN 10 according to the third embodiment of the present invention can select whether to perform mobility management on each of the plurality of interfaces of the MN 10, using mobile IPv6, by the MN 10 itself, or allow mobility management to be performed on the network side using PMIPv6. The selection is made based on, for example, judgment regarding whether the network to which the interface is connected is implementing PMIPv6. When the network to which the interface is connected does not implement PMIPv6, mobility IPv6 can be operated. When the network to which the interface is connected implements PMIPv6, the mobility IPv6 is not operated. The MN 10 can also select whether to use mobile IPv6 or PMIPv6 by taking into consideration network connection status (communication speed, stability, and fees) and the like.

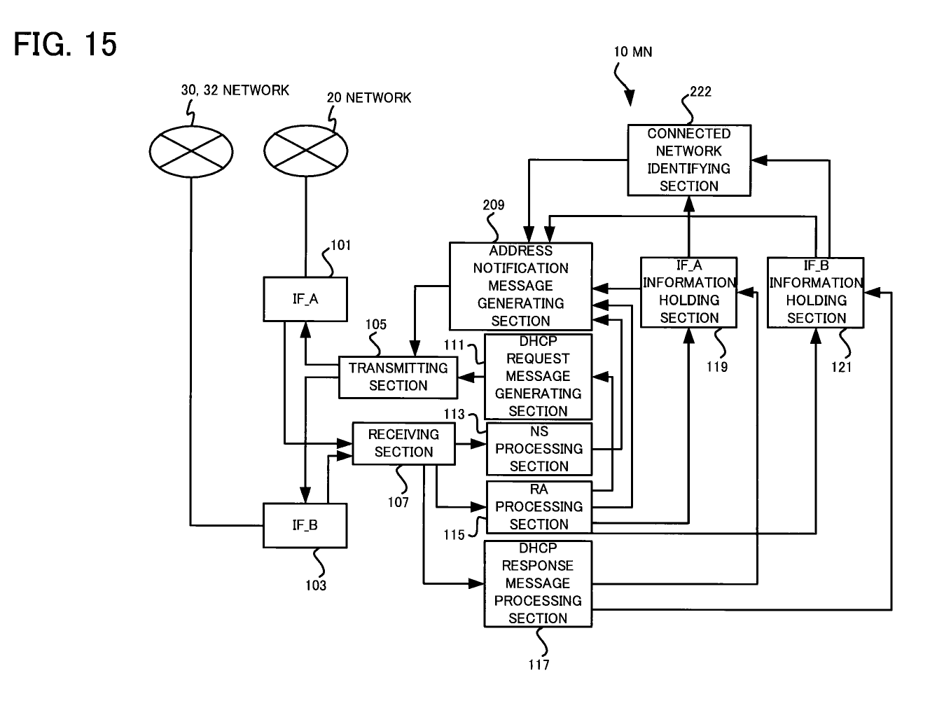

Next, constituent elements of the MN 10 shown in FIG. 15 will be described. FIG. 15 is a diagram of an example of a configuration of a mobile node according to the third embodiment of the present invention. The mobile node 10 shown in FIG. 15 includes the two interfaces (IF_A and IF_B) 101 and 103, the transmitting section 105, the receiving section 107, an address notification message generating section 209, the DHCP request message generating section 111, the NS processing section 113, the RA processing section 115, the DHCP response message processing section 117, the IF_A information holding section 119, the IF_B information holding section 121, and a connected network identifying section 222. The constituent elements other than the address notification message generating section 209 and the connected network identifying section 222 basically provide the same functions as the constituent elements according to the first embodiment (constituent elements of the MN 10 shown in FIG. 2). Explanations thereof are omitted.

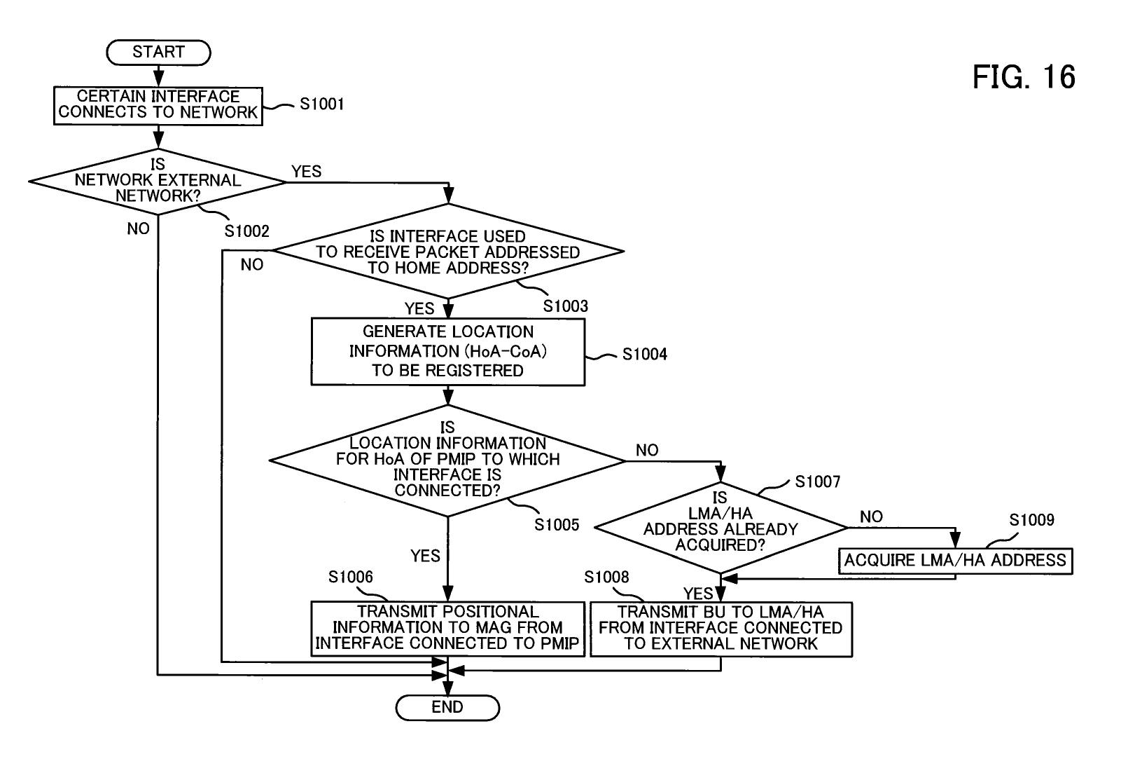

First, the connected network identifying section 222 of the MN 10 shown in FIG. 15 will be described. The connected network identifying section 222 determines whether the networks to which the interfaces (IF_A and IF_B) 101 and 103 are connected implement PMIPv6. The connected network identifying section 222 selects use of PMIPv6 when the network is implementing PMIPv6. On the other hand, the connected network identifying section 22 selects use of mobile IPv6 when the network is not implementing PMIPv6. The connected network identifying section 222 provides a function of performing processes shown in FIG. 16, described hereafter (a process for confirming presence of an interface connected to a network in which PMIPv6 is operating, a process for, when an interface is connected to the network in which PMIPv6 is operating, transmitting MIPv6 binding information from the interface, and the like).

FIG. 16 is a flowchart of an example of processes performed by the connected network identifying section 222 and related constituent elements when the MN is connected to a certain network, according to the third embodiment of the present invention. When a certain interface on the MN 10 is connected to a network (Step S1001), the connected network identifying section 222 judges whether the network is an external network from the perspective of the MN 10 (Step S1002).

When the network is an external network (for example, when the interface [IF_B 103] switches connection from the network 32 to the network 30, as shown in FIG. 14), the connected network identifying section 222 judges whether to use the interface to receive a packet addressed to the home address (Step S1003).

When the interface is used to receive the packet addressed to the home address (in other words, when a home address associated with an address used in the external network as the care-of address is present), the connected network identifying section 222 performs a process so that location information (HoA-CoA) to be registered is generated (Step S1004). The connected network identifying section 22 also judges whether a registration destination of the location information is the LMA/HA in the PMIP domain to which the other interface is connected (Step S1005).

When the registration destination of the location information is the LMA/HA in the PMIP domain to which the other interface is connected, the connected network identifying section 222 instructs the address notification message generating section 209 to transmit the location information to the MAG (or the PMA) from the interface connected to the PMIP domain (Step S1006).

On the other hand, when the registration destination of the location information is not the LMA/HA in the PMIP domain to which the other interface is connected, a BU message (address notification message) is transmitted directly to the LMA/HA from the interface connected to the external network. At this time, the connected network identifying section 222 checks whether the address of the LMA/HA that is the transmission destination of the BU message is already acquired. When the address of the LMA/HA is already acquired, the BU is transmitted directly to the LMA/HA from the interface connected to the external network (Step S1008). When the address of the LMA/HA is not yet acquired, the address of the LMA/HA is acquired by an HA retrieval process or the like (Step S1009). Then the BU is transmitted directly to the

LMA/HA from the interface connected to the external network (Step S1008).

In FIG. 14, when the home address of the MN 10 is the address 1 and the address 2, the address used in the network 30 that is the external network becomes the care-of address for both the address 1 and the address 2. Regarding the relationship between the address 1 and the address 2, the address 2 can be considered to be the care-of address for the address 1, and the address 1 can be considered to be the care-of address for the address 2. In the former instance, the network 32 is the external network in relation to the network 20. In the latter instance, the network 20 is the external network in relation to the network 32.

An instance can also be considered in which the home network of the MN 10 is a home network implementing mobile IPv6. In this instance, the connected network identifying section 222 is required to judge whether the home network to which the other interface is connected is a home network implementing PMIPv6 or a home network implementing mobile IPv6. The judgment is made as a result of an RA message, an NS message, an NA message including information (IsPMIP information) indicating that PMIPv6 is implemented, and the like being received. The MN 10 can acquire the address of a proxy node from the transmission source address set in these messages.

Whether the connected network is implementing PMIPv6 can be checked when the MN 10 connected to a network and authentication is performed. In addition, the MN 10 can know that the connected network is implementing PMIPv6 from static information. When, as a result, the connected network is a home network implementing PMIPv6, the connected network identifying section 222 instructs the address notification message generating section 209 to transmit an address notification message to the proxy node from the interface connected to the home network. In this instance, because the transmission destination of the address notification message is the proxy node, the MN 10 is not required to perform a process, such as DHAAD, required to acquire the address of the LMA/HA. On the other hand, when the connected network is a home network implementing mobile IPv6, the connected network identifying section 22 instructs the address notification message generating section 209 to transmit an address notification message to the LMA/HA from the interface connected to the home network. In this instance, the MN 10 is required to acquire the address of the LMA/HA that is the transmission destination of the address notification message. The address notification message is transmitted after the address of the LMA/HA is acquired.

Next, the address notification message generating section 209 of the MN 10 shown in FIG. 15 will be described. The address notification message generating section 209 provides a function for receiving an instruction from the connected network identifying section 222, generating an address notification message for notifying the home agent (LMA/HA) of the care-of address, and instructing the transmitting section 105 to transmit the generated address notification message.

When an instruction is received from the connected network identifying section 222 to transmit the address notification message from the interface connected to the PMIP domain, the address notification message generating section 209 generates an address notification message in which the address of the proxy node advertising the home prefix is set as the destination address.

The address notification message transmitted from the interface connected to the PMIP domain can be a mobile IPv6 BU message or an NA message. When the BU message is used as the address notification message, the BU message can include information indicating that the BU message includes the address of the other interface as the CoA to allow the proxy node receiving the BU message to recognize that the received message is not an ordinary BU message, but rather a message requesting registration of the address of the other interface of the MN 10 via the proxy node. For example, a mobility option having a new type can be used as an option including the CoA of the other interface of which notification is being given. Alternatively, the request for registration of the address of the other interface can be indicated by a new flag being set within an alternate CoA option in mobile IPv6. Alternatively, a mobility header having a similar format but a different type as that of the BU message can be used.

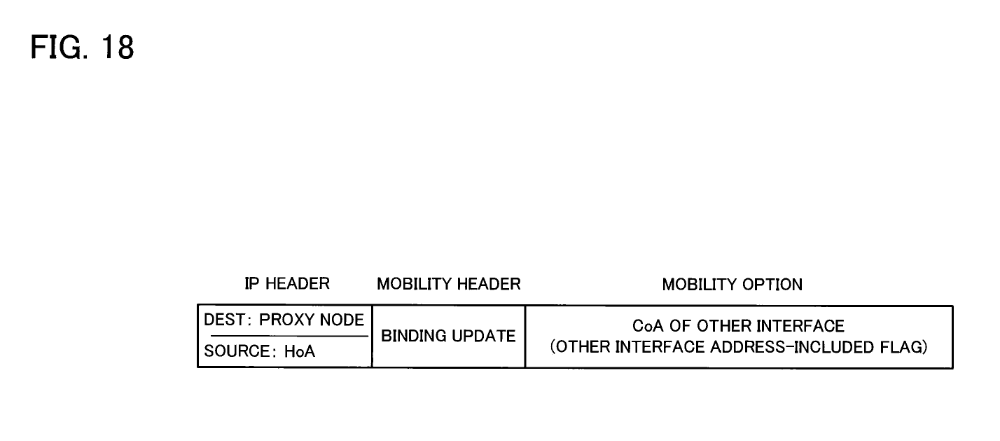

The address notification message using the BU message is basically formatted as shown in FIG. 18. In FIG. 18, an example of a format of the address notification message using the BU message according to the third embodiment of the present invention is shown. As shown in FIG. 13, the proxy node is set in the address notification message as the destination address. The HoA of the MN 10 is set as the transmission source address. For example, the CoA of the other interface is inserted into the mobility option, or a flag indicating that the CoA carried by the BU message is the CoA of the other interface is set.

As described above, the MN 10 can acquire the address of the proxy node from the transmission source address of the received RA message, NS message, NA message and the like. However, the MN 10 can acquire the address of the proxy node using different method. For example, the MN 10 can acquire the address of the proxy node during an authentication process performed when the MN 10 connects with the network. The destination address of the address notification message can be the address of the proxy node itself acquired by a method such as that described above. Alternatively, an arbitrary address that allows reception by the proxy node, such as an all-routers multicast address, an all-nodes multicast address, or a link local address, can be used.

On the other hand, when an instruction is given to transmit the address notification message from the interface connected to the external network, the address notification message generating section 209 sets the address of the home agent as the destination address and transmits the address notification message. At this time, when the address of the home agent is not yet acquired, the address of the home agent is acquired through use of DHAAD or the like. The address notification message generating section 209 then transmits the address notification message in which the acquired address of the home agent is set as the destination address.

In the MN 10 according to the third embodiment of the present invention, when the location information is registered at the LMA/HA, whether an interface connected to the PMIP domain managed by the LMA/HA is present is checked. When the interface connected to the PMIP domain managed by the LMA/HA is present, the address notification message can be transmitted from the interface via a proxy node in the PMIP domain. Therefore, the MN 10 can register the location information via the proxy node, without being required to perform a process for acquiring the address of the LMA/HA.

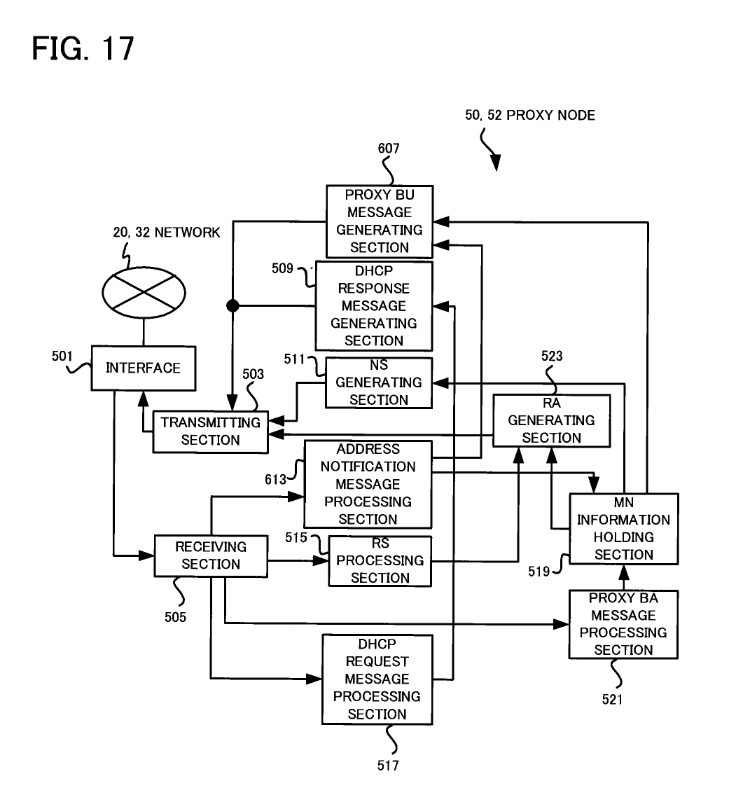

Next, constituent elements of the proxy node shown in FIG. 17 will be described. FIG. 17 shows an example of a configuration of a proxy node according to the third embodiment. The proxy node 50 shown in FIG. 17 includes the interface 501, the transmitting section 503, the receiving section 505, a proxy BU message generating section 607, the DHCP response message generating section 509, the NS generating section 511, an address notification message processing section 613, the RS processing section 515, the DHCP request message processing section 517, the MN information holding section 519, the proxy BA message processing section 521, and the RA generating section 523. The constituent elements other than the proxy BU message generating section 607 and the address notification message processing section 613 basically provide the same functions as the constituent elements according to the first embodiment (constituent elements of the proxy node 50 shown in FIG. 5). Explanations thereof are omitted.

The address notification message processing section 613 performs processes related to the address notification message received from the MN 10. The address notification message processing section 613 provides a function of acquiring the home address and the care-of address of the MN 10 included in the message, and instructing the MN information holding section 519 to hold the acquired addresses. In addition, the address notification processing section 613 provides a function of identifying the MN 10 using the home address as a key, and instructing the MN information holding section 519 to hold the care-of address as the address of the other interface of the MN 10. MN-ID can be used as information used to identify the MN 10.

When the other interface address-included flag indicating that the address of the other interface is included as the care-of address is included as, for example, in the address notification message shown in FIG. 18, the address notification message processing section 613 can recognize that the message differs from the BU message ordinarily transmitted to the HA, based on the information.

The address notification message processing section 613 provides a function for instructing the proxy BU message generating section 607 to generate a proxy BU message including the address of the other interface of the MN 10 included within the received address notification message as the care-of message.

For example, in the network configuration shown in FIG. 14, the address acquired on the network 30 by the interface (IF_B) 103 of the MN 10 is included in the address notification message by the MN 10 as the care-of address. At this time, the address notification message processing section 613 instructs the proxy BU message generating section 607 to generate a proxy BU message for registering the address of the interface (IF_B) 103 of the MN 10 at the home agent as the care-of address.

On the other hand, when the address notification message by the MN 10 is an address notification message requesting deletion of the address, the address notification message processing section 613 instructs the proxy BU message generating section 607 to generate a proxy BU message for deleting the address of the other interface included in the address notification message from the home agent. A mobile IPv6 BU message is preferably used as the address notification message. However, an NA message can also be used.

When the instruction from the address notification message processing section 613 is to register the address, the proxy BU message generating section 607 provides a function of generating a proxy BU message for registering the received address as the care-of address, sending the generated proxy BU message to the transmitting section 503, and instructing the transmitting section 503 to transmit the generated proxy BU message. On the other hand, when the instruction from the address notification message processing section 613 is to delete the address, the proxy BU message generating section 607 can generate a proxy BU message for deleting a registered entry of the received address. The proxy BU message generating section 607 can then send the generated proxy BU message to the transmitting section 503, and instruct .the transmitting section 503 to transmit the generated proxy BU message. The proxy BU message in this instance includes the home address in the area including the address indicating the care-of address.

The proxy BU message generating section 607 can also indicate information indicating that the address to be registered by the proxy BU message is the address of the other interface of the MN 10 and not the ordinarily registered address of the proxy node 50 by, for example, a flag within the proxy BU message shown in FIG. 6. The proxy BU message generating section 607 can also insert the address of the other interface into the proxy BU message option to which a new type is set, such as that shown in FIG. 7, and add the option to the proxy BU message.

The proxy BU message generating section 607 can add a BID to the proxy BU message including the address of the other interface of the MN 10. The BID is added to differentiate between an already registered binding cache and a binding cache to be registered. The proxy BU message generating section 607 can also add a BID to an ordinary BU message including the address of the proxy node itself as the care-of address for differentiation from other binding caches.

In the proxy node according to the third embodiment of the present invention, the address of the other interface can be acquired from the MN 10. The proxy node can register the acquired address at the LMA/HA on behalf of the MN 10. Moreover, as a result of the proxy node adding a BID to the location information to be registered, the MN 10 is not required to perform BID management. Moreover, the proxy node can differentiate the location information to be registered from the location information of the proxy node itself already registered at the LMA/HA.

Each functional block used in the explanations of the embodiment of the present invention, described above, can be actualized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI.

The method of forming the integrated circuit is not limited to LSI and can be actualized by a dedicated circuit or a general-purpose processor. A field programmable gate array (FPGA) that can be programmed or a reconfigurable processor of which connections and settings of the circuit cells within the LSI can be reconfigured can be used after LSI manufacturing.

Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

The present invention achieves an effect in which flow filtering associated with a packet destined for a mobile terminal can be actualized while minimizing processes performed by the mobile terminal in a network environment in which a network-based mobility protocol is operating. The present invention can be used in a technical field related to a network-based mobility protocol, such as proxy mobile IPv6, and in a technical field for performing flow filtering on a mobile terminal having a plurality of interfaces and addresses.

1. A mobile terminal comprising:
at least two communication interfaces;
an address setting means for setting an address on each of said communication interface;
a judging means for judging whether a communication interface is connected to a domain network in which a network-based mobility protocol is operating; and
an other interface address notifying means for giving notification of an address set on a second communication interface differing from a first communication interface connected to the domain network in which the network-based mobility protocol is operating to a proxy node that functions as a proxy for the mobile terminal and is located on the domain network to which the first communication interface is connected.

2. The mobile terminal according to claim 1, comprising:
a neighbor advertisement message transmitting means for inserting the address set on the second interface into a neighbor advertisement message, and transmitting the neighbor advertisement message including the second address to the proxy node.

3. The mobile terminal according to claim 2, wherein, when receiving a neighbor solicitation message from the proxy node including information requesting the address set on the second communication interface differing from the first communication interface connected to the domain network, the neighbor advertisement message transmitting means transmits the neighbor advertisement message including the second address.

4. The mobile terminal according to claim 1, comprising:
a binding update transmitting means for, when the communication interface connected to the domain network in which the network-based mobility protocol is operating is not present, giving notification of the address set on the second communication interface to a home agent of the mobile terminal from the second communication interface.

5. The mobile terminal according to claim 1, wherein:
when location information in which a care-of address assigned to a communication interface is associated with a home address is registered at a home agent,
the judging means judges whether a communication interface differing from the communication interface to which the care-of address to be registered is assigned is connected to a network that manages the home address in the location information and implements the network-based mobility protocol; and
the other interface address notifying means gives notification of the location information to the proxy node that functions as the proxy for the mobile terminal from the communication interface connected to the network that manages the home address in the location information and implements the network-based mobility protocol.

6. The mobile terminal according to claim 1, comprising:
a binding update transmitting means for, when the communication interface connected to a network that manages the home address in the location information and implements the network-based mobility protocol is not present, giving notification of the location information to a home agent of the mobile terminal from the communication interface to which the care-of address to be registered is assigned.

7. A communication management device comprising:
a proxy node function executing means for providing a function as a proxy for a mobile terminal connected to a domain network implementing a network-based mobility protocol and in which the network-based mobility protocol is operating; and
an other interface address receiving means for receiving, from a mobile terminal that has at least one communication interface, an address set on another communication interface differing from a communication interface of the mobile terminal connected to the domain network.

8. The communication management device according to claim 7, comprising:
an address requesting means for inserting address request information requesting the address set on the other communication interface differing from the communication interface of the mobile terminal connected to the domain network into a neighbor solicitation message, and transmitting the neighbor solicitation message including the address request information to the mobile terminal.

9. The communication management device according to claim 7, comprising:
a transfer destination address notifying means for registering the address set on the other communication interface, received from the other interface address receiving means, at a certain address management device as a potential packet transfer destination for a packet destined for the mobile terminal, the certain address management device transferring the packet destined for the mobile terminal connected to the domain network and managing an address of the mobile terminal.
